(19) United States
(12) Patent Application Publication
(10) Pub. No.: US 2015/0266059 A1
(43) Pub. Date: Sep. 24, 2015

(54) ULTRASONIC PROBE

(71) Applicant: KABUSHIKI KAISHA TOSHIBA, Minato-ku (JP)

(72) Inventors: Haruka KUBO, Yokohama (JP); Jun Morimoto, Yokohama (JP)

(73) Assignee: KABUSHIKI KAISHA TOSHIBA, Minato-ku (JP)

(21) Appl. No.: 14/643,350

(22) Filed: Mar. 10, 2015

(30) Foreign Application Priority Data
Mar. 18, 2014 (JP) 2014-055262

(51) Int. Cl. B06B 1/06

(52) U.S. Cl. CPC B06B 1/0622

(57) ABSTRACT

According to an embodiment, an ultrasonic probe includes a backing plate, a piezoelectric element, and a protective layer. The piezoelectric element has a piezoelectric vibrator. The piezoelectric element is provided on the backing plate. The protective layer is provided on the surface of an end of the piezoelectric element on the side of the backing plate. Compressive stress is applied to the inside of the protective layer, and the transmission rate of sound inside the protective layer is a predetermined rate.

### CROSS-REFERENCE TO RELATED APPLICATIONS

This application is based upon and claims the benefit of priority from Japanese Patent Application No. 2014-055262, filed Mar. 18, 2014; the entire contents of which are incorporated herein by reference.

### FIELD

Embodiments described herein relate generally to an ultrasonic probe which outputs ultrasonic waves by using a piezoelectric element and receives the reflected ultrasonic waves.

### BACKGROUND

There has been suggested an ultrasonic probe which outputs ultrasonic waves by using a piezoelectric element and receives the reflected ultrasonic waves. In the ultrasonic probe of this type, a reinforcing layer is provided in the piezoelectric element, and the space between adjacent piezoelectric elements is filled with a charging material, so that the piezoelectric elements are improved in mechanical strength.

### BRIEF DESCRIPTION OF THE DRAWINGS

FIG. 1 is a perspective view showing an ultrasonic probe according to a first embodiment;

FIG. 2 is a sectional view showing a head portion of the same ultrasonic probe;

FIG. 3 is a sectional view showing a head portion of an ultrasonic probe according to a second embodiment; and

FIG. 4 is a sectional view showing a head portion of an ultrasonic probe according to a third embodiment.

### DETAILED DESCRIPTION

According to an embodiment, an ultrasonic probe includes a backing plate, a piezoelectric element, and a protective layer. The piezoelectric element has a piezoelectric vibrator. The piezoelectric element is provided on the backing plate. The protective layer is provided on the surface of an end of the piezoelectric element on the side of the backing plate. Compressive stress is applied to the inside of the protective layer, and the transmission rate of sound inside the protective layer is a predetermined rate.

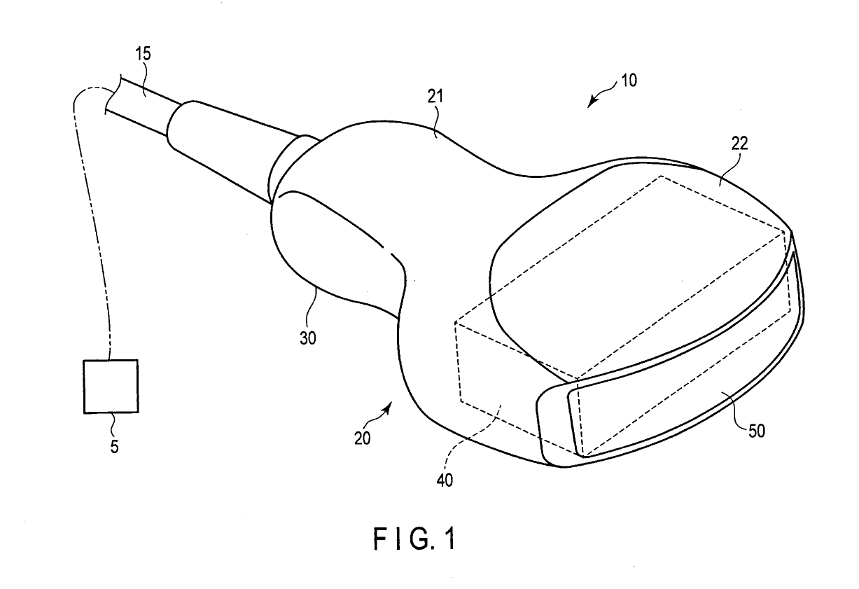

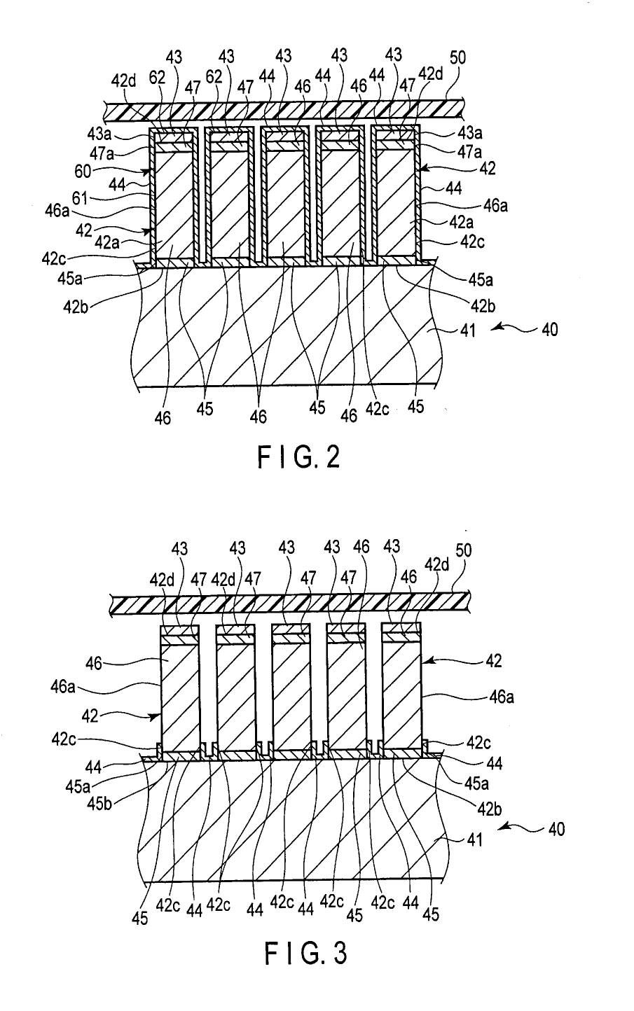

An ultrasonic probe according to a first embodiment is described with reference to FIGS. 1 and 2. FIG. 1 is a perspective view showing an ultrasonic probe 10. As shown in FIG. 1, the ultrasonic probe 10 includes a body 20, and a cable 15 for sending/receiving signals to/from a diagnostic apparatus 5. The body 20 has a casing 30, a detector 40 stored in the casing 30, and an acoustic lens 50 which is provided at a position to face the detector 40 in the casing 30 and exposed from the surface of the casing 30.

An end of the casing 30 where the cable 15 is pulled out is a handle 21 which is formed to be graspable by an operator. The part of the body 20 opposite to the handle 21 is a head portion 22 which is formed to be able to emit ultrasonic waves. The head portion 22 has the above-mentioned detector 40 and acoustic lens 50.

FIG. 2 is a sectional view showing the head portion 22. As shown in FIG. 2, the detector 40 has a backing plate 41, piezoelectric elements 42 stacked on the backing plate 41, acoustic matching layers 43 stacked on the piezoelectric elements 42, and protective layers 44 stacked on stacks 60 composed of the piezoelectric elements 42 and the acoustic matching layers 43. The casing 30 is not shown in FIG. 2. Although the detector 40 has multiple stacks 60, some of the stacks are not shown in FIG. 2, and five stacks 60 are shown.

The backing plate 41 mechanically supports later-described piezoelectric vibrators 46 of the piezoelectric elements 42, and is formed to be able to control the piezoelectric vibrators 46 to reduce an ultrasonic pulse. The backing plate 41 has a thickness sufficient for the wavelength of ultrasonic waves to be used to maintain satisfactory acoustic characteristics, i.e., a thickness that can sufficiently dampen the ultrasonic waves emitted to the backing plate 41 by the later-described piezoelectric vibrators 46.

Multiple piezoelectric elements 42 are provided on the backing plate 41 apart from one another. The piezoelectric elements 42 have the same structure. The piezoelectric elements 42 have first electrode portions 45, the piezoelectric vibrators 46, and second electrode portions 47. The first electrode portions 45 are stacked on the backing plate 41. The piezoelectric vibrators 46 are stacked on the first electrode portions 45. The second electrode portions 47 are stacked on the piezoelectric vibrators 46.

The electrode portions 45 and 47 are electrically connected to a signal line for sending/receiving signals that extends through the cable 15, and are formed to be able to apply a drive signal voltage from the diagnostic apparatus 5 to the piezoelectric vibrators 46. The electrode portions 45 and 47 are also formed to be able to send a voltage generated by the piezoelectric vibrators 46 to the diagnostic apparatus 5.

The piezoelectric vibrators 46 are formed to be able to vibrate in response to the voltages applied from the electrode portions 45 and 47. The piezoelectric vibrators 46 are formed to be able to generate a voltage on receipt of ultrasonic waves. The piezoelectric vibrators 46 are made of piezoelectric ceramics by way of example. A Young's modulus E1 of the piezoelectric ceramics is 62 GPa. A density ρ1 of the piezoelectric ceramics is 7.9 g/cm³. A transmission rate C1 of sound inside the piezoelectric ceramics is √(E1/ρ1). The transmission rate of sound inside the piezoelectric vibrators 46 made of the piezoelectric ceramics is also the same value.

The acoustic matching layers 43 are stacked on the second electrode portions 47. The acoustic matching layers 43 are formed to be able to match the acoustic impedances of a sample and the piezoelectric vibrators 46.

The protective layer 44 is stacked on all the surfaces of the stacks 60 composed of the piezoelectric elements 42 and the acoustic matching layers 43 except for the parts fixed to the backing plate 41. More specifically, the stack 60 is a rectangular parallelepiped by way of example, and the protective layer 44 is stacked on the entire circumferential surface 61 of the stack 60 around the direction in which the stack 60 extends, and on an upper surface 62 of the stack 60.

The circumferential surface 61 has a circumferential surface 45a of the first electrode portion 45, a circumferential surface 46a of the piezoelectric vibrator 46, a circumferential surface 47a of the second electrode portion 47, and a circumferential surface 43a of the acoustic matching layer 43. The upper surface 62 is the upper surface of the acoustic matching layer 43.

In other words, the protective layer 44 is provided on all surfaces of the stacks 60 except for bottom surfaces 42b fixed to the backing plate 41. The protective layer 44 is also stacked on parts of the surface of the backing plate 41 between adjacent stacks 60.

The protective layer 44 is formed so that compressive stress is applied within it. As a result of the application of the compressive stress to the inside of the protective layer 44, compressive force is applied to the piezoelectric elements 42 and the acoustic matching layers 43 that are surrounded by the protective layer 44. In particular, the compressive force is applied to the surface portions of the piezoelectric elements 42 which contact the protective layer 44. The degree of the compressive stress applied to the inside of the protective layer 44 will be described in detail later.

The protective layer 44 has a thickness such that it does not fill the space between the stacks 60. That is to say, a space is formed between adjacent stacks 60.

The transmission rate of sound inside the protective layer 44 is the same as the transmission rate of sound inside the piezoelectric vibrators 46. More specifically, the protective layer 44 is made of diamond like carbon (DLC) as the material. A Young's modulus E2 of DLC is 100 to 800 GPa. A density ρ2 of DLC is 1.4 to 3.5 g/cm³. A transmission rate C2 of sound inside the protective layer 44 is √(E2/ρ2). The Young's modulus E2 and density ρ2 of the DLC constituting the protective layer 44 are adjusted so that the transmission rate C2 of sound inside the protective layer 44 may be the same as the transmission rate C1 of sound inside the piezoelectric vibrators 46.

Now, one example of a manufacturing method of the detector 40 is described. First, the material to form the first electrode portion 45 is stacked on the backing plate 41 by a film forming technique such as CVD or sputtering. The piezoelectric vibrator 46 is then attached onto the first electrode portion 45 by, for example, an adhesive agent. The material to form the second electrode portion 47 is then stacked on the first electrode portion 45 by a film forming technique such as CVD or sputtering. The second electrode portion 47 is then coated with the material to form the acoustic matching layer 43.

The layers stacked on the backing plate 41 are then cut into the stacks 60 composed of the piezoelectric elements 42 and the acoustic matching layers 43 by a cutter such as a dicing saw.

The protective layer 44 is then formed on a stack composed of the backing plate 41 and the stacks 60 by a film forming technique such as CVD or sputtering. A film forming condition for forming the protective layer 44 is a condition under which desired compressive stress is generated in the protective layer 44. This condition can be found, for example, by experiment.

Even if the ultrasonic probe 10 having such a configuration falls, damage to the piezoelectric elements 42 can be prevented. This is concretely described next.

The cable 15 extends outward from the side of the handle 21 of the ultrasonic probe 10. The operator grasps the handle 21 to operate the ultrasonic probe 10. Thus, the ultrasonic probe 10 tends to fall in such a manner that the acoustic lens 50 is at the bottom relative to the handle 21.

The detector 40 is located to face the acoustic lens 50 in the head portion 22. Thus, the impact resulting from the fall of the ultrasonic probe 10 tends to be transmitted to the detector 40 through the acoustic lens 50.

When the impact is transmitted to the stacks 60, the backing plate 41 is bent. Due to the bending of the backing plate 41, tensile force is applied to the piezoelectric elements 42 fixed to the backing plate 41.

However, in the present embodiment, the protective layer 44 is stacked on all circumferential surfaces of the piezoelectric elements 42. Compressive stress is applied to the inside of the protective layer 44, and due to this compressive stress, compressive stress is also applied to the insides of the piezoelectric elements 42.

Thus, even if tensile force is applied to the piezoelectric elements 42 as described above, this tensile force counteracts the compressive stress in the piezoelectric elements 42 generated by the protective layer 44, so that deformation of the piezoelectric elements 42 is prevented, and damage to the piezoelectric elements 42 can therefore be prevented. Moreover, the transmission rate of sound inside the protective layer 44 is the same as the transmission rate of sound inside the piezoelectric vibrators 46. Therefore, there is no acoustic characteristic deterioration. Thus, it is possible to prevent acoustic characteristic deterioration and prevent damage to the piezoelectric elements in the event of falling.

Compressive stress in the protective layer 44 can be determined, for example, by an experiment so that the piezoelectric element 42 is not damaged by the compressive stress even when the ultrasonic probe 10 falls from an assumed height, for example, when the operator drops the ultrasonic probe 10.

The surface portion of the piezoelectric element 42 may be cracked when the piezoelectric element 42 is diced as in the present embodiment. However, the protective layer 44 is formed on the piezoelectric element 42, so that extension of the crack is prevented by the compressive stress resulting from the protective layer 44. Thus, growth of the crack is prevented, and damage to the piezoelectric elements 42 can therefore be prevented. In particular, a crack tends to grow at the end of the piezoelectric element 42 on the side of the backing plate 41 due to the application of tensile force. However, growth of the crack can be prevented by the protective layer 44. Thus, providing the protective layer 44 on circumferential surfaces 42c of ends 42a of the piezoelectric elements 42 on the side of the backing plate 41 is advantageous.

The protective layer 44 is in the shape of a ring that is continuous around the direction in which the stack 60 extends. A round around the direction in which the stack 60 extends is the same as a round around the direction in which the piezoelectric element 42 projects from the backing plate 41. This further ensures that the stack 60 can be supported by the protective layer 44.

Now, an ultrasonic probe according to a second embodiment is described with reference to FIG. 3. Components having functions similar to those in the first embodiment are denoted with the same reference numerals as those in the first embodiment, and are not described. The second embodiment is different in the protective layer 44 from the first embodiment. The structure is the same as that in the first embodiment in other respects. The difference is concretely described.

FIG. 3 is a sectional view showing the head portion 22 according to the present embodiment cut in the same manner as in FIG. 2. In the present embodiment, for example, the stacks 60 composed of the piezoelectric elements 42 and the acoustic matching layers 43 are separately formed one by one without being diced. In this case, the surface portion of the piezoelectric element 42 is not easily cracked.

As shown in FIG. 3, the protective layer 44 is formed on the circumferential surfaces 42c of the ends 42a of the piezoelectric elements 42 on the side of the backing plate 41. The circumferential surface 42c has the circumferential surface 45a of the first electrode portion 45, and an end of the circumferential surface 46a of the piezoelectric vibrator 46 on the side of the first electrode portion 45. Tensile force is applied more strongly to the end 42a than to other parts by the bending of the backing plate 41. The protective layer 44 is in the shape of a ring that is continuous in the circumferential direction of the end 42a. The protective layer 44 is also provided on the part of the backing plate 41 between adjacent stacks 60.

Thus, when the surfaces of the piezoelectric elements 42 are not easily cracked, it is also possible to prevent acoustic characteristic deterioration and prevent damaging of the piezoelectric elements in the event of falling by forming the protective layer 44 at the ends 42a to which tensile force is strongly applied due to the falling.

The protective layer 44 covers the surfaces the ends of the piezoelectric vibrators 46 on the side of the backing plate 41, so that damage to the relatively easily damaged piezoelectric vibrator 46 can be prevented.

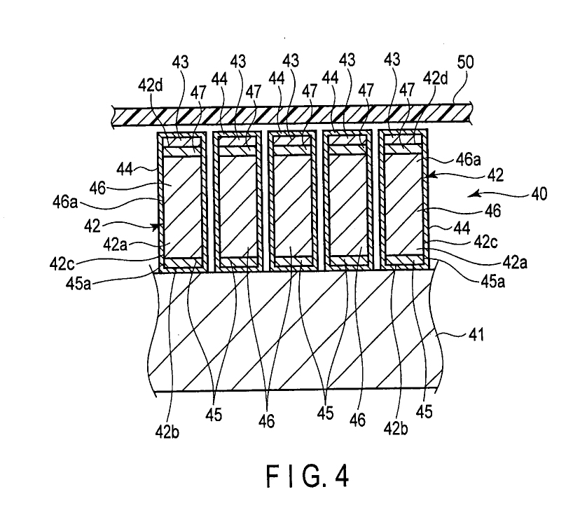

Now, an ultrasonic probe according to a third embodiment is described with reference to FIG. 4. Components having functions similar to those in the first embodiment are denoted with the same reference numerals as those in the first embodiment, and are not described. The third embodiment is different in the protective layer 44 from the first embodiment. The structure is the same as that in the first embodiment in other respects. The difference is described.

FIG. 4 is a sectional view showing the head portion 22 according to the present embodiment cut in the same manner as in FIG. 2. As shown in FIG. 4, the protective layer 44 may be formed on all surfaces of the stacks 60 composed of the piezoelectric elements 42 and the acoustic matching layers 43. Specifically, the protective layer 44 is provided on the circumferential surfaces 61 and upper surfaces 62 of the stacks 60 and on the bottom surfaces 42b which serve as the bottom surfaces of the stacks 60.

According to the present embodiment, advantageous effects similar to those according to the first embodiment are provided. The protective layer 44 covers all of the bottom surfaces 44b, so that damage to the piezoelectric elements caused by falling can be further prevented.

The protective layer 44 shown in the second embodiment may be further provided on the bottom surfaces 44b in the same manner as the protective layer 44 according to the third embodiment.

In the first to third embodiments, the transmission rate C2 of sound inside the protective layer 44 is the same as the transmission rate C1 of sound inside the piezoelectric vibrators 46 by way of example. The transmission rate C2 of sound inside the protective layer 44 is the same as the transmission rate C1 of sound inside the piezoelectric vibrators 46, so that there is no acoustic characteristic deterioration. That is to say, the performance of the ultrasonic probe 10 is not affected.

The transmission rate C2 of sound inside the protective layer 44 has only to be within such a range that the acoustic characteristic deterioration of the ultrasonic probe 10 caused by the protective layer 44 does not affect the required performance of the ultrasonic probe 10. Thus, the transmission rate C2 of sound inside the protective layer 44 and the transmission rate C1 of sound inside the piezoelectric vibrators 46 do not need to be the same, and may be, for example, substantially the same.

In the first and third embodiments, the protective layer 44 is formed on the surfaces of the stacks 60, and is therefore formed on the acoustic matching layers 43. In another example, the protective layer 44 may be only formed on the piezoelectric elements 42 without being formed on the acoustic matching layers 43.

Described in more detail, the protective layer 44 is formed on the circumferential surfaces 42c and upper surfaces 42d of the piezoelectric elements 42.

Alternatively, the protective layer 44 is formed on the circumferential surfaces 42c, upper surfaces 42d, and bottom surfaces 42b of the piezoelectric elements 42. The acoustic matching layers 43 are then formed on the protective layer 44.

According to the embodiments described above, it is possible to provide an ultrasonic probe in which damage to the piezoelectric elements in the event of falling can be prevented.

While certain embodiments have been described, these embodiments have been presented by way of example only, and are not intended to limit the scope of the inventions.

Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An ultrasonic probe comprising:
a backing plate;
a piezoelectric element which has a piezoelectric vibrator and which is provided on the backing plate; and
a protective layer provided on the surface of an end of the piezoelectric element on the side of the backing plate, compressive stress being applied to the inside of the protective layer, the transmission rate of sound inside the protective layer being a predetermined rate.

2. The ultrasonic probe according to claim 1, wherein the protective layer is provided on the surface of an end of the piezoelectric vibrator on the side of the backing plate.

3. The ultrasonic probe according to claim 1, wherein the protective layer is formed into a shape of a ring that is continuous around a direction in which the piezoelectric element projects from the backing plate.

4. The ultrasonic probe according to claim 1, wherein the protective layer is provided on the entire circumferential surface of the piezoelectric vibrator around a direction in which the piezoelectric element projects from the backing plate.
